(19) United States
(12) Patent Application Publication
(10) Pub. No.: US 2025/0353470 A1
(43) Pub. Date: Nov. 20, 2025

(54) ADAPTER FOR A WIPER SYSTEM

(71) Applicant: VALEO SYSTEMES D'ESSUYAGE, La Verriere (FR)

(72) Inventors: Stephane HOUSSAT, La Verriere (FR); Vincent GAUCHER, La Verrière (FR); Guillaume MOULEYRE, La Verrière (FR); Olivier JOMARD, La Verrière (FR)

(73) Assignee: VALEO SYSTEMES D'ESSUYAGE, La Verriere (FR)

(21) Appl. No.: 18/866,616

(22) PCT Filed: May 17, 2023
(86) PCT No.: PCT/EP2023/063402

§ 371 Date: Nov. 18, 2024

(30) Foreign Application Priority Data
May 19, 2022 (FR) 2204810

(51) Int. Cl. B60S 1/40

(52) U.S. Cl. CPC B60S 1/4003; B60S 1/4006; B60S 1/4009

(57) ABSTRACT

The invention relates to an adapter for a device for connecting a wiper blade to an arm of a wiper system. The connection device includes at least a connection module and the adapter which extends in a longitudinal main extent direction. The adapter includes fastening means for at least a plurality of different types of wiper arms, the fastening means being configured to provide at least four different fastening planes in each of the longitudinal and transverse directions and also in a vertical direction perpendicular to these two longitudinal and transverse directions.

### TECHNICAL FIELD

The present invention relates to the field of wiper systems for automotive vehicles. More particularly, the present invention relates to the field of connection devices positioned between a wiper arm and a wiper blade of such wiper systems.

### BACKGROUND OF THE INVENTION

Automotive vehicles are commonly fitted with wiper systems for cleaning their glazed surfaces, and in particular their windshields. Such wiper systems comprise at least one wiper arm and a wiper blade driven by the wiper arm. The wiper arm is connected to an electric motor of the vehicle and the wiper blade comprises at least one wiper rubber intended to come into contact with the glazed surface to be wiped.

A connection device is arranged between this wiper blade and the wiper arm so that the wiper blade can be driven. More particularly, the connection device comprises an adapter arranged between the wiper arm and a connector attached to the wiper blade. The adapter is then secured to the wiper arm, and more particularly to a free end of the wiper arm, this cooperation being reversible such that the wiper blade can be changed when it is worn.

However, different types of wiper arms are currently fitted to motor vehicles, forcing automotive equipment manufacturers to design different adapters specific to each type of arm, with one adapter specifically connecting one type of wiper arm to one connector. This feature firstly pushes equipment manufacturers to develop many different adapters, with at least one for each type of wiper arm on the market, and secondly requires users needing to change their wiper blade to adapt and pay extra attention when selecting the right adapter for the type of wiper arm on which the wiper blade is to be mounted.

### SUMMARY OF THE INVENTION

The present invention falls into this field and proposes a universal connection device between a wiper blade and an arm, i.e. a connection device allowing connection of a wiper blade to at least two different types of arm currently on the market.

The invention therefore concerns an adapter for a device for connecting a wiper blade to an arm of a wiper system, the connection device comprising at least a connection module and the adapter which extends in a longitudinal main extent direction, the adapter comprising at least two side walls opposite one another in a transverse direction of the adapter, and at least one upper wall which extends in a longitudinal and transverse plane so as to connect the side walls together, the adapter comprising reversible fixing means configured to removably fix the adapter to the connection module, characterized in that the adapter comprises fastening means for at least a plurality of different types of wiper arms, the fastening means being configured to provide at least four different fastening planes in each of the longitudinal and transverse directions and also in a vertical direction perpendicular to these two longitudinal and transverse directions.

The wiper blade and the wiper arm form part of a wiper system of a vehicle for at least partially cleaning a glazed surface of said vehicle. The wiper system more particularly comprises the wiper arm, an electric motor configured to rotate the arm and allow, as the blade moves as one with the arm via the connection device and where applicable the adapter forming the object of the present invention, a back and forth movement of the wiper blade along the glazed surface and cleaning of this glazed surface by a rubber borne by the wiper blade.

As has been stated, the adapter according to the invention is configured to cooperate with different types of wiper arm so that it is possible to use a same connection module and a same adapter for fixing a blade to different types of wiper arm. This standardization helps limit costs for the user and facilitates the mounting operations since it is no longer necessary to ensure that the connection module or the adapter mounted on this connection module is indeed the correct part for fixing a particular wiper arm.

To this end, the adapter comprises a plurality of fastening means which are configured to define multiple fastening planes in each of the three directions—longitudinal, vertical and transverse—perpendicular to one another, and at least the one and/or the other of these fastening planes is operational depending on the type of wiper arm to be fixed to the blade. A connection assembly formed on the adapter and dedicated to the fixing of a type of wiper arm may therefore be formed by several of the fastening means present on the adapter, given that a same fastening means may form part of multiple connection assemblies. In other words, a fastening means may form a first connection assembly with a first group of other fastening means, and also, to cooperate with another type of wiper arm, a second connection assembly with a second group of other fastening means.

According to a characteristic of the invention, the fastening means are configured to provide at least five fastening planes in the longitudinal direction.

According to a characteristic of the invention, the fastening means are configured to provide at least six fastening planes in the longitudinal direction.

According to a characteristic of the invention, the fastening means are configured to provide at least five fastening planes in the transverse direction.

According to a characteristic of the invention, the fastening means are configured to provide at least five fastening planes in the vertical direction.

According to a characteristic of the invention, the first fastening means are configured to form two fastening paths for a type of wiper arm along the upper wall, being a longitudinal fastening path and a transverse fastening path. The longitudinal fastening path is in particular configured to receive a hook-type wiper arm, the arm coming to rest on the upper wall of the adapter, with first fastening means arranged on either side of this longitudinal fastening path and forming two separate fastening planes in a transverse direction, in order to fasten said hook-type wiper arm in each direction. The transverse fastening path is in particular configured to receive a type of wiper arm with side fixing, arranged on the side of a side wall of the adapter and having a support lug which comes to rest on the upper wall of the adapter in the transverse fastening path in order to come into engagement on the other side wall, wherein first fastening means are arranged on either side of this transverse fastening path so as to form two separate fastening planes in a longitudinal direction, in order to fasten the support lug of this wiper arm with side fixing in each direction. In each of these cooperations, the upper wall forms a fastening plane in a vertical direction perpendicular to the longitudinal and transverse directions.

According to a characteristic of the invention, the fastening means comprise additional fastening means which are offset at least longitudinally relative to the first fastening means, the first fastening means and the additional fastening means being configured to allow, in synergistic fashion, the fixing of another type of wiper arm and/or the fixing of a cover element of the connection module. The additional fastening means help form at least a fastening plane in the longitudinal direction and a fastening plane in the vertical direction, which are separate from the fastening planes formed by the first fastening means. Also, in this synergistic fixing of the first fastening means and additional fastening means, the first fastening means provide a contribution on an upper face, turned opposite the upper wall of the adapter, which forms a specific fastening plane in a vertical direction.

According to a characteristic of the invention, the side walls and the upper wall delimit a receiving space of the connection module, the reversible fixing means being formed in this receiving space.

According to a characteristic of the invention, the fixing means are formed in the receiving space of the platform of the connection module.

According to a characteristic of the invention, the fixing means are formed protruding from the side walls of the adapter. The positioning of the fixing means on the side walls, which have a free end opposite the upper wall and are therefore flexible about an axis of flexion formed at the junction of the side walls with the upper wall, allows an elastic clip fixing—which is therefore reversible—of the adapter to the platform of the connection module.

According to a characteristic of the invention, the fixing means comprise at least one support wall turned towards the upper wall of the adapter. This support wall forms a stop element which helps block the position of the adapter on the platform when the fixing means resume their original position under the elastic return of the side walls of the adapter.

According to a characteristic of the invention, a hook extends from the upper wall of the adapter, at least partially towards the receiving space of the platform. This hook helps form fixing means which allow the adapter to be held in position on the rotating platform of the connection module.

According to a characteristic of the invention, the first fastening means comprise at least two studs protruding from the upper wall of the adapter, the studs being arranged such that the side faces of the studs at least partially delimit the fastening paths and define two different fastening planes in each of the longitudinal and transverse directions.

According to a characteristic of the invention, the first fastening means comprise four studs, each stud participating in forming the two different fastening planes in each of the longitudinal and transverse directions.

According to a characteristic of the invention, the studs have an upper face perpendicular to the side faces, said upper faces defining a separate vertical fastening plane parallel to a vertical fastening plane defined by the upper wall.

According to a characteristic of the invention, the additional fastening means comprise at least one elastically deformable locking tab which longitudinally extends the one of the side walls of the adapter.

According to a characteristic of the invention, the at least one locking tab comprises at least one overthickness which protrudes transversely from a free end of said locking tab, the overthickness forming an additional longitudinal fastening plane, an additional transverse fastening plane, and an additional vertical fastening plane for the other type of wiper arm and/or the cover element of the connection module.

According to a characteristic of the invention, one of the fastening means comprises a stop means locally extending the one of the side walls opposite the upper wall, said stop means being configured to form a longitudinal fastening plane or a vertical fastening plane.

According to a characteristic of the invention, at least one of the connection assemblies comprises at least one through-hole formed on the at least one of the side walls of the adapter. This hole or these holes are configured and dimensioned to receive a fixing shank of a wiper arm with side fixing, wherein to this end, each hole and the peripheral edge delimiting it form two fastening planes in the longitudinal direction and two fastening planes in the vertical direction, perpendicular to the extent direction of the shank along which the shank is inserted in the hole or holes.

According to a characteristic of the invention, the through-hole is formed on the side wall at the second longitudinal end of the adapter.

The invention also concerns a connection assembly comprising an above-mentioned adapter and a connection module, the adapter being able to be removably fixed to the connection module via the reversible fixing means.

The invention also concerns a device for connecting a wiper blade to an arm of a wiper system, the connection device comprising at least one connector able to be fixed to the wiper blade and the above-described connection assembly, wherein the connection assembly is attached to the connector by a cooperation of the connector with the connection module. The connection module may in particular be pivotably mounted on the connector secured to the wiper blade, this pivot axis allowing, in a generally known manner, a pivoting of the assembly formed by the connector and the wiper blade relative to the wiper arm in order to adapt the position of the wiper blade against the glazed surface to be wiped during the back and forth movement of the wiper blade.

According to a characteristic of the invention, the connection module comprises a base which is pivotably mounted on the connector, and a platform which is mounted on the base so as to be rotatable around a transverse rotational axis, the adapter being removably fixed to the platform via the reversible fixing means. In this case, the connection module is divided into at least two parts which are rotatable relative to one another, namely the base which provides the pivoting function of the connection module relative to the connector as described above, and the rotary platform which is mounted movably relative to the base. The connection module may then be configured such that the transverse rotational axis is longitudinally offset relative to the pivot axis formed between the base and the connector, allowing generation of an angular movement of the platform relative to the base which is sufficient to allow, in a release position of the platform relative to the base, the adapter fixed to the platform to cooperate with different types of wiper arm independently of the base, the platform and the base being also configured to lock the position of these different types of wiper arm once the position of the platform is fixed relative to that of the base.

The invention also relates to a wiper blade comprising at least one wiper rubber and a connection device similar to that described above, the rubber being borne directly or indirectly by the connector, and the connection module being mounted pivotably relative to the connector.

The invention also concerns a wiper system for a vehicle which comprises a wiper blade secured to the connection device similar to that described above, and an arm attached to the wiper blade by the securing of the arm to the adapter of the connection module, the arm being fastened in each of the longitudinal, vertical and transverse directions at least by the adapter, and the different fastening planes formed by the fastening means contained therein.

### BRIEF DESCRIPTION OF DRAWINGS

Further features, details and advantages of the invention will become more clearly apparent upon reading the description given below by way of indication with reference to drawings, in which:

FIG. 1 is a perspective illustration of a wiper blade on which a connection device according to the invention is mounted;

FIG. 2 is an exploded view of the wiper blade and the connection device shown in FIG. 1;

FIG. 3 is a perspective view of a connector, a connection module comprising a base and a rotary platform, and a cap, forming the connection device shown in FIG. 1;

FIG. 4 is a perspective view of the connection module and the cap shown in FIG. 3, in which the rotary platform is in a mounting position;

FIG. 5 is a perspective view, seen from above, of the rotary platform shown in FIG. 3;

FIG. 6 is a perspective view of an adapter of the connection device mounted on the rotary platform;

FIG. 7 is a perspective view of the adapter from FIG. 6;

FIG. 8 is a perspective view from below of an end of a wiper arm according to a first type mounted on the adapter from FIG. 6, the associated connection device not being shown here in order to display the adapter;

FIG. 9 is a perspective view, seen from above, of the arm from FIG. 8 mounted on the connection device;

FIG. 10 is a sectional view along a longitudinal plane of the arm from FIG. 8 mounted on the connection device;

FIG. 11 is a perspective view of a wiper blade and a connection device cooperating with a wiper arm according to a second type, the arm here covering the adapter from FIG. 6;

FIG. 12 is a sectional view of the wiper blade, the connection device and the wiper arm according to a second type, as illustrated in FIG. 11;

FIG. 13 is a perspective view of a wiper blade and a connection device cooperating with a wiper arm according to a third type, said arm cooperating in particular with the adapter from FIG. 6; and

FIG. 14 is a perspective view of a wiper blade and a connection device cooperating with a wiper arm according to a fourth type, said arm cooperating in particular with the adapter from FIG. 6.

### DETAILED DESCRIPTION OF THE INVENTION

Firstly, it should be noted that while the figures disclose the invention in detail for the implementation thereof, these figures clearly can be used to better define the invention, where appropriate. It also should be noted that these figures merely disclose exemplary embodiments of the invention.

The features, variants and different embodiments of the invention may be combined with one another in various combinations, provided that they are not mutually incompatible or exclusive. In particular, variants of the invention may be imagined comprising only a selection of features described hereinafter in isolation from the other features described, if this selection of features is sufficient to confer a technical advantage and/or to differentiate the invention from the prior art.

In the figures, elements that are common to multiple figures retain the same reference sign.

In the following detailed description, the terms “longitudinal”, “transverse” and “vertical” refer to the orientation of a wiper system according to the invention. A longitudinal direction corresponds to a main extent direction of a wiper blade of the wiper system, and in the present case to the main extent direction of an adapter which is the subject of the invention and participates in fixing this blade to an arm of the wiper system, this longitudinal direction being parallel to a longitudinal axis L of a coordinate system L, V, T shown on the figures. A vertical direction corresponds to a stacking direction of a connector and a connection module on which said adapter is mounted, with this vertical direction being parallel to a vertical axis V of the coordinate system L, V, T, and this vertical axis V being perpendicular to the longitudinal axis L. Finally, a transverse direction corresponds to a direction parallel to a transverse axis T of the coordinate system L, V, T, with this transverse axis T being perpendicular to the longitudinal axis L and to the vertical axis V.

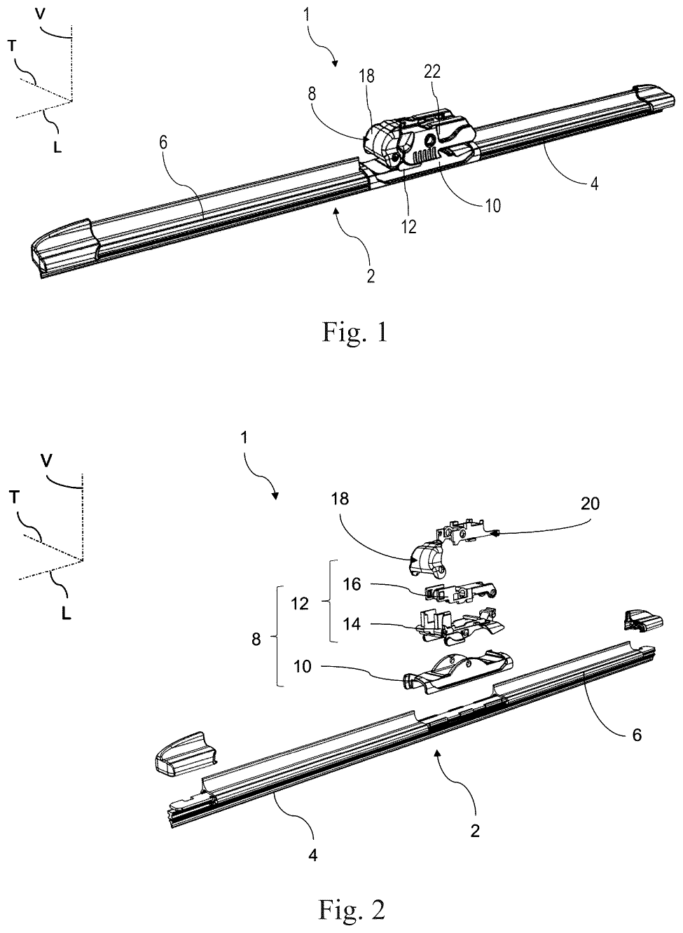

FIG. 1 shows a wiper system 1 configured for cleaning a glazed surface of a vehicle, for example a windshield, so as to improve a driver's view of the road in front of the vehicle. The wiper system 1 comprises at least one wiper arm, not shown in FIG. 1, which at one end bears a wiper blade 2 extending principally in the longitudinal direction L.

The wiper blade 2 comprises at least one wiper rubber 4 intended to be in contact with the glazed surface to be cleaned, and a support 6 of said wiper rubber 4.

The wiper blade 2 is also secured to the wiper arm by a connection device 8. The connection device 8 according to the invention comprises at least one connector 10 and a connection module 12 which is mounted pivotably on the connector 10, the latter being secured to the wiper blade 2 while the connection module 12 is intended to be secured to the wiper arm of the wiper system 1.

The pivotable mounting of the connection module 12 on the connector 10 thus allows the wiper blade 2 to pivot at the one end of the wiper arm and thus ensure that the wiping rubber 4 is pressed onto the glazed surface to be wiped.

In the example illustrated, and as shown on FIG. 2 to FIG. 4, the connection module 12 comprises a base 14 which is mounted pivotably around a pivot axis P on the connector 10, and a rotary platform 16 which is mounted rotatably about a rotational axis R on the base 14.

It should be noted that, according to the invention and as will be described in detail below, the connection device is distinguished in that it comprises a removable adapter providing a plurality of fastening planes in various directions, so as to allow the fixing of a large number of different types of wiper arm to a same adapter mounted on the connection module. Such a configuration may be implemented irrespective of the presence of a rotary platform mounted pivotably on the base. The description below gives details of the structure of the rotary platform, without this being limiting for the invention.

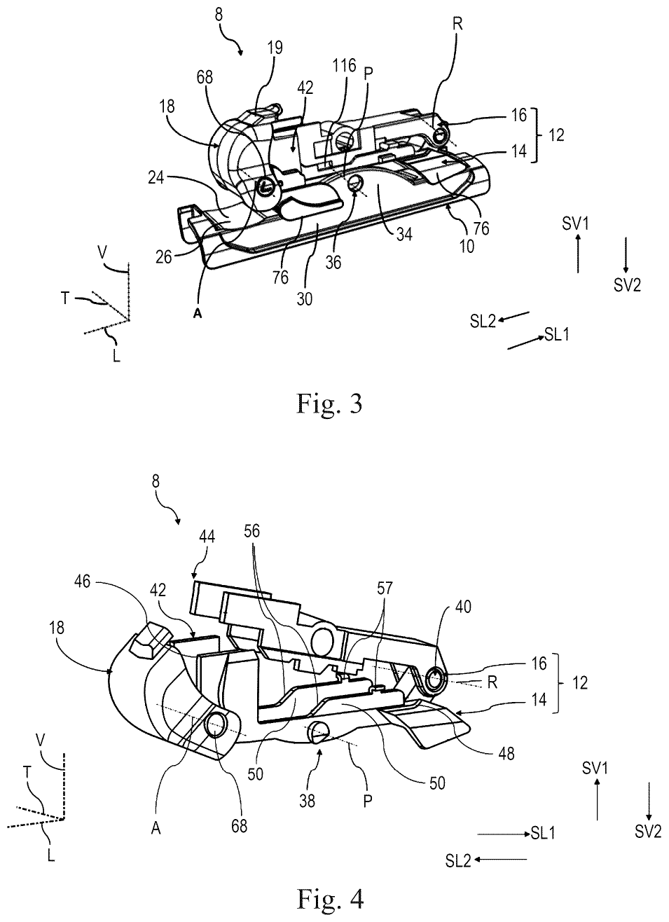

As visible more particularly on FIG. 3, the pivot axis P and the rotational axis R may extend parallel to and separately from one another. In the example illustrated, the pivot axis P is formed substantially in the centre of the base 14 relative to the longitudinal dimension of this base, and the rotational axis R is formed at one of the longitudinal ends of the base 14. The longitudinal offset of the rotational axis R relative to the pivot axis P allows the rotary platform to swivel into a mounting position which is inclined relative to the longitudinal and transverse plane of the base as shown on FIG. 4, the swivelling of this rotary platform allowing mounting of certain types of wiper arm on this connection device 8.

The pivot axis P and the rotational axis R may be vertically offset to one another.

As visible in particular in FIG. 2 and FIG. 4, the connection device 8 comprises a cap 18 mounted so as to be pivotably movable about a pivot axis A, which in the illustrated example is parallel to the pivot axis P and the rotational axis R. The pivot axis A is here formed at a longitudinal end of the base 14 which is opposite the longitudinal end where the rotational axis R is formed. The cap 18 is configured to be movable between a covering position, fixing certain types of wiper arm to the connection device 8, and a release position, allowing mounting of certain types of wiper arm on the connection device 8.

According to the invention, the connection device 8—as visible on FIG. 2—comprises a removable adapter 20 which is configured to be fixed on the connection module as a function of the type of wiper arm to be associated with the blade, wherein the adapter 20 with this connection module forms an assembly configured to allow cooperation between the connection device 8 and certain types of wiper arm which cannot be fixed directly to one of the components of the connection module. In the example illustrated, the adapter 20 is mounted on the rotary platform 16, but—as stated above—the configuration of the adapter and its distinctive features are not linked to the presence or absence of a rotary platform within the connection module, and the adapter 20 may be fixed to any component of the connection module 12.

The connector 10, the connection module 12 and—in the illustrated example of a connection module comprising a base 14 and a rotary platform 16—the cap 18 will now be described in more detail.

The connector, shown on FIG. 3, comprises at least one main wall 24 extending substantially parallel to the longitudinal L and transverse directions T, the main wall 24 comprising an upper face 26 facing the connection module 12 and a lower face (not visible) facing the wiper blade. More particularly, the lower face of the main wall 24 helps delimit a housing for the blade and in particular for the support of the wiper rubber.

The connector 10 comprises two flat faces 34, only one of which is visible here, which extend parallel with one another and protrude from the upper face 26 of the main wall 24, each flat face 34 extending a side wall 30 of the connector 10. These two flat faces 34, which extend opposite the lower face of the main wall 24, help at least partially delimit a housing of the base 14. The flat faces 34 each have a convexly curved free end, and are symmetrical to one another relative to a median plane of the connector 10 parallel to the longitudinal L and vertical directions V.

At least one of the two flat faces 34 comprises a pivoting element 36 able to cooperate with a pivoting member 38 of the base 14, so as to form a pivoting device between the connector 10 and the base 14. Preferably, each of the two flat faces 34 comprises a pivoting element 36 cooperating with a pivoting member 38 of the base 14, wherein the openings of the pivoting elements 36 are aligned in the transverse direction T.

The pivoting element 36 here takes the form of an orifice formed in the flat face 34, here an orifice passing transversely through the flat face 34, while the pivoting member 38 takes the form of a pin intended to extend at least partially into the orifice. The cooperation of the orifice and the pin thus forms the pivoting device.

The base 14 of the connection module 12, which is particularly clear in FIG. 4, comprises at least one rotational member 40 able to cooperate with the rotary platform 16 in order to allow the platform to rotate relative to the base 14 around the rotational axis R, and a guide block 42 intended to receive a free end 44 of the rotary platform 16. The base 14 extends longitudinally, having a first longitudinal end 46, close to which the guide block 42 is arranged, and a second longitudinal end 48, close to which the rotational member 40 is arranged.

The rotational member 40 allows the rotation of the rotary platform 16 between a first working position, shown in FIG. 3, in which the free end 44 of the rotary platform 16 is arranged in the guide block 42, and a second mounting position, shown in FIG. 4, in which the free end 44 of the rotary platform 16 is arranged at a distance from the guide block 42.

Thus the first position is defined as a working position of the rotary platform 16, and the second position as a mounting position of the rotary platform 16. In other words, considering a longitudinal L and vertical plane V, in the working position the main extent axis of the base 14 is substantially parallel to the main extent axis of the platform, and in the mounting position an angle of inclination is formed between the main extent axis of the platform and the main extent axis of the base. According to the invention, the angle of inclination may lie between 25° and 45°.

The base 14 comprises at least two longitudinal walls 50, extending in the longitudinal direction L between the first longitudinal end 46 and the second longitudinal end 48 and parallel to one another, and two transverse walls extending perpendicularly and between the longitudinal walls 50, a first transverse wall being arranged at the first longitudinal end 46 of the structure and facing the guide block 42, while the second transverse wall is arranged at the second longitudinal end 48 and bears the rotational member 40.

At least one longitudinal wall 50 bears the above-mentioned pivoting member 38, which is configured to cooperate with the pivoting element 36 of the connector 10. It is understood that the pin of the pivoting member 38 extends towards the outside of the longitudinal wall 50 bearing it, i.e. opposite the other longitudinal wall, in order to cooperate with the orifice of the pivoting element 36 borne by the corresponding flat wall 34 of the connector 10.

The longitudinal walls 50 are spaced apart from one another such that they extend between the flat walls 34 of the connector 10 when the base 14 is clip-fixed to the connector, the base 14 extending at least partially into the housing defined by the flat walls 34 of the connector 10 as described above. Furthermore, the longitudinal walls 50 each have a notch 56 extending longitudinally on an upper edge of the longitudinal wall 50.

Also, the base 14 comprises a pivot member 68 able to cooperate with a pivot element of the cap 18 so as to form a pivot device between the base and the cap around the pivot axis A. The cap 18 is thus movable between a covering position, in which the cap 18 is in contact with the guide block, at least partially covering the housing of the free end 44 of the rotary platform 16 and of an end of a wiper arm fixed to the connection device, and a release position, in which the cap 18 is at a distance from the guide block 42 so as to allow in particular the mounting of a wiper arm on the rotary platform in its mounting position.

Also, a protrusion 57 extends from at least the one of the longitudinal walls 50, from the upper edge of said longitudinal wall 50, at a distance from the opposite longitudinal wall. This protrusion 57 helps form a means for mounting a particular type of arm directly onto the base. In the example illustrated, protrusions 57 are arranged on each of the longitudinal walls, and it may be provided that these protrusions are formed at the transverse ends of a reinforcing bridge which extends transversely from one longitudinal wall to the other.

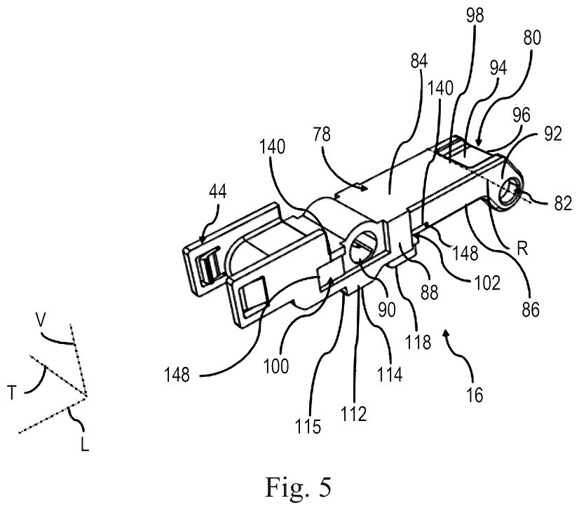

The rotary platform 16 of the connection module 12, shown in FIG. 5, comprises a body 78 extending in the longitudinal direction L between the free end 44, configured to cooperate with the guide block 42, and a longitudinal edge 80 on which an element 82 is fitted for rotation of the rotary platform 16 about the rotational axis R.

The body 78 generally takes the form of a wall extending mainly in a plane parallel to the longitudinal L and transverse directions T; it has an upper surface 84, designed to face the wiper arm to be fixed on the connection device or on the adapter to be fixed between the platform and the wiper arm, a lower face (not shown) intended to face the base, and two lateral flanks 88.

The rotary platform 16 comprises a bore 90 intended to form a bearing 90 for receiving a shank of a wiper arm, the bore 90 extending transversely in the body 78 and opening on at least one of the lateral flanks 88.

The above-mentioned rotational element 82 is in particular configured to cooperate with the rotational member 40 of the base 14, so that it can rotate the rotary platform 16 between the first working position and the second mounting position as described above. The rotational element 82 here comprises two rotational lugs 92, each comprising an orifice passing transversely through the rotational lug 92 and configured to cooperate with the one of the supporting faces of the rotational member 40 of the base 14. A rotational lug 92 is a form which is distinguished from the lateral flanks 88 firstly by a vertical extension towards the base 14 and secondly by a longitudinal extension of these lateral flanks 88 opposite the free end 44 of the rotary platform 16.

According to the invention, the rotary platform 16 comprises a guide wall 94 extending in a plane parallel to and separate from the longitudinal L and transverse plane T in which the upper surface 84 of the body 78 extends between the rotational lugs 92 of the rotational element 82. In other words, the guide wall 94 forms a vertical relief relative to the upper surface 84 of the body 78.

The guide wall 94 has a stop edge 96 able to come into contact with a means for limiting the rotation of the base when the rotary platform 16 is in the second mounting position, so as to limit the rotation of the rotary platform 16 about the rotational axis R. The stop edge 96 is in particular arranged at the longitudinal end of the rotary platform 16 opposite the free end 44, and extends transversely between the rotational lugs 92. Also, at least one of the lateral flanks 88 comprises a support member 112 protruding from the ridge between the lower surface 86 and this lateral flank 88, so as to form a support edge 114 turned towards the base 14, this support edge 114 being intended to come to rest on the upper edge of the longitudinal wall of the base at the notch 56 when the rotary platform 16 is in the first working position. The support member 112 also forms a stop shoulder 115 between the lower surface 86 and the support edge 114. As illustrated in FIG. 3, which shows this working position of the rotary platform 16, the specific forms of the stop shoulder 115 and notch 56 help define an opening 116 which itself participates in blocking a specific type of wiper arm in position relative to the connection module 12, such a cooperation forming the subject of the detailed description below.

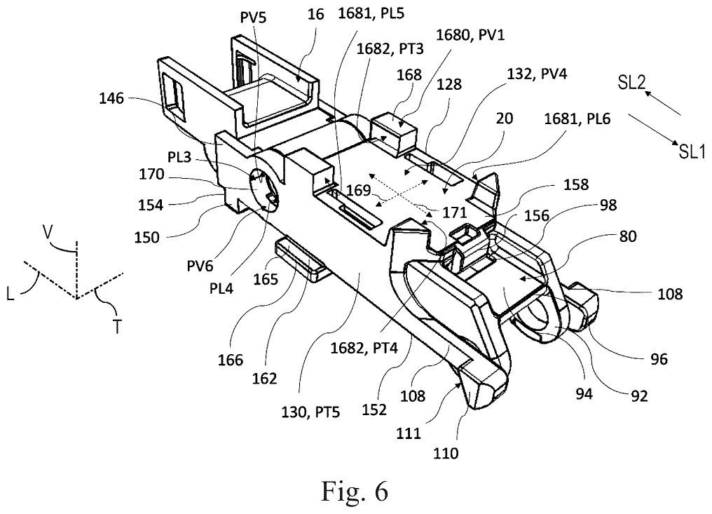

Also, the rotary platform 16 is configured to cooperate with the removable adapter 20, as shown on FIG. 6, so as to fix the removable adapter 20 on the rotary platform 16. For example, the rotary platform 16 comprises a window 98 formed by the vertical offset between the guide wall 94 and the body 78 of the rotary platform 16, the window 98 being intended to receive a hook 156 of the adapter 20, shown on FIG. 6.

Furthermore, the rotary platform 16 comprises at least one zone 100 for fixing the removable adapter 20 on the body 78 of the rotary platform 16, the fixing zone 100 taking the form of an indentation made in the thickness of the lateral flank 88 of the body 78. Preferably, the rotary platform 16 comprises a first pair of fixing zones 100, each produced in a lateral flank of the adapter and arranged on either side of a median plane of the rotary platform perpendicular to the rotational axis R, and a second pair of fixing zones 102, also produced in a lateral flank of the adapter and arranged on either side of this median plane, and offset longitudinally relative to the fixing zones of the first pair. These fixing zones 100, 102 are dimensioned to receive fixing means provided on the removable adapter.

A description has been given of means provided on the rotary platform for cooperating with the removable adapter, which is the subject of the present invention, but it should be recalled here that the connection module 12 could assume a form other than that described with a base and a rotary platform, and that in this case the means borne here by the rotary platform would be provided by another component of the connection module.

The cap 18 of the connection device 8, shown on FIG. 3 and FIG. 4, is mounted pivotably on the base at a pivot member 68 formed thereon, so as to form a pivot device between the base and the cap around the pivot axis A. The cap 18 is thus movable between a covering position shown in FIG. 3, in which the cap 18 is in contact with the guide block 42, at least partially covering the free end 44 of the rotary platform 16 when the latter is in the guide block 42, and a release position shown in FIG. 4, in which the cap 18 is at a distance from the guide block 42, so as to allow in particular the rotation of the rotary platform and the mounting of a type of wiper arm on the rotary platform in its mounting position. Here, the pivot element of the cap is an orifice, and the pivot member 68 comprises at least one shaft which protrudes transversely from the base 14 close to the first longitudinal end 46.

The cap 18 also comprises at least one extension wall 19 which extends in a longitudinal L and transverse plane T towards the connection module 12, and which comprises at least one inner surface 21 turned towards the free end 44 of the rotary platform 16 when the cap 18 is in its covering position. It is understood that such an extension wall 19 is intended to form a vertical stop means against the release of a type of wiper arm in a first vertical direction SV1.

The adapter 20, which is the subject of the present invention, will now be described in more detail, in particular the fastening means of the adapter, which are configured for allowing the connection of the adapter to different types of wiper arm of the wiper system. More particularly, the adapter comprises multiple fastening means which help form a plurality of fastening surfaces in each of the longitudinal, vertical and transverse directions, wherein some of these different fastening surfaces are used in combination with one another, depending on the type of wiper arm to be secured to the adapter. For greater understanding, the different fastening means will firstly be described separately, specifying the fastening surfaces they offer in a particular plane, and the connection assemblies formed by the use of particular fastening means will be described secondly.

The adapter 20, which is particularly clearly shown in FIG. 6 to FIG. 8, comprises a main body 128 which comprises at least two side walls 130 opposite one another in the transverse direction T of the wiper system, and at least one upper wall 132 which extends in a longitudinal L and transverse plane T such that it connects the side walls 130 together. The arrangement of these walls gives the adapter a U shape, viewed in cross-section in the vertical and transverse plane, which internally delimits a receiving space 134 which is configured in particular to at least partially accommodate the components of the connection module 12 and for example, in the example illustrated, the rotary platform.

The adapter 20 comprises reversible fixing means 136 allowing the removable fixing of the adapter to the connection module. In the example illustrated, these fixing means 136 protrude from the side walls 130 into the receiving zone 134, these fixing means 136 being able to cooperate with fixing zones present on the connection module, and more particularly here with the above-described fixing zones of the rotary platform 16. The positioning of the fixing means 136 on the side walls of the adapter 20 facilitates the mounting of the adapter 20 on the connection module 12 by elastic deformation of said side walls, such that the fixing means 136 can clip into said fixing zones of the connection module. The fixing of the adapter 20 on the connection module is thus removable, in the sense that said adapter can be withdrawn from the connection module and/or repositioned thereon depending on the type of wiper arm to be secured to the blade, by moving the side walls apart so as to allow release of the fixing means 136.

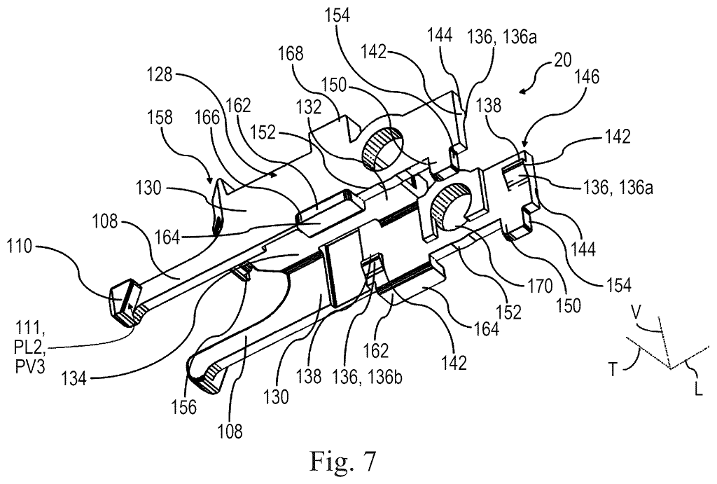

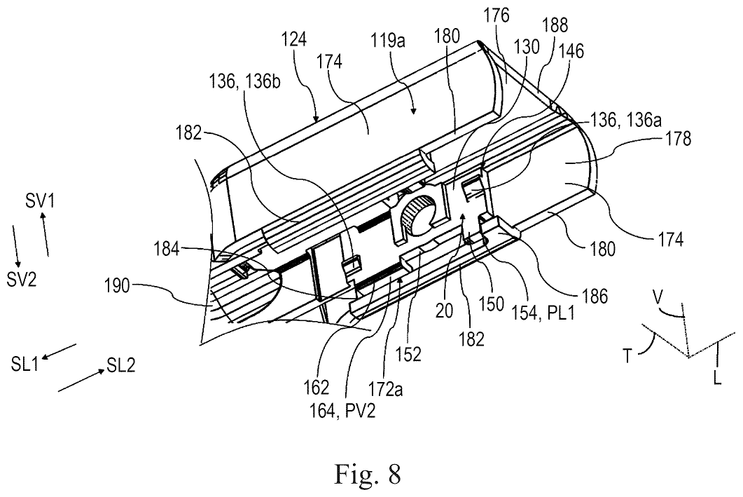

As is particularly clear on FIG. 7 and FIG. 8, the adapter 20 comprises a first pair of fixing means 136a and a second pair of fixing means 136b, which protrude from a same side wall 130 and extend into the receiving space 134, these pairs of fixing means being intended to cooperate respectively with the first pair of fixing zones and the second pair of fixing zones which are here provided on the rotary platform 16. According to the example of the invention in FIG. 7, the fixing means 136a, 136b take the form of pegs, each comprising a support wall 138 turned towards the upper wall 132 of the adapter 20 and able to cooperate with a longitudinal receiving face 140 of the fixing zones 100, 102 shown in FIG. 5. Once the pegs forming the fixing means 136 are in position in the fixing zones, the support wall 138 allows the adapter 20 to be blocked in position on the connection module in the vertical direction V. The pegs here take the form of a ramp, such that the thickness of the peg increases as it becomes closer to the support wall 138.

Also, each of the fixing means 136a, 136b is delimited longitudinally by two longitudinal end edges 142. In the example illustrated here, fixing means are arranged close to a first longitudinal end 146 of the main body 128 of the adapter 20, such that one of the longitudinal end edges 142 of these fixing means, here the first pair of fixing means 136a, is flush with a free end edge 144 of the corresponding side wall 130. It should be noted that this feature does not limit the invention and that another arrangement of this longitudinal end edge 142 of the fixing means could be implemented, in particular at a distance from the free end edge 144 of the corresponding side wall. Each of the longitudinal end edges 142 of a fixing means 136a is able to cooperate with a stop face 148, longitudinally delimiting one of the fixing zones and shown in FIG. 5, wherein such a cooperation allows the adapter 20 to be blocked in position on the connection module 12 in both opposite directions in the longitudinal direction L.

As shown on FIG. 6 and FIG. 7, the hook 156, which is able to cooperate with the window 98 formed on the rotary platform 16 as described above, extends from the upper wall 132 of the adapter 20 at a second longitudinal end 158 of the main body 128 of said adapter 20, longitudinally opposite the first longitudinal end 146. The hook 156 of the adapter 20 in particular holds the adapter 20 in the vertical direction V and in a direction along the longitudinal direction L.

As shown in the example of the adapter 20 in FIG. 7, at least one of the side walls 130 comprises a protuberance 150, which extends from a vertical end edge 152 of the main body 128 of the adapter 20 at the first longitudinal end 146. The protuberance 150 extends opposite the upper wall 132 in the vertical direction V, such that it extends substantially in the extent plane of the side wall 130, which it locally extends. One of the fastening means provided on the adapter, which participates in ensuring that at least four separate fastening planes are provided for both the longitudinal direction and for the transverse direction and the vertical direction, is formed by vertical shoulder 154 between the free end edge 144 of the side wall 130 and the protuberance 150 extending said side wall 130, the vertical shoulder forming a longitudinal stop means and hence one of the specific fastening planes allowed by the adapter, here a longitudinal fastening plane. According to the example of the invention, each of the two side walls 130 comprises such a protuberance 150 and such a vertical shoulder 154, the latter participating in the mounting of a specific type of wiper arm which forms the subject of the detailed description given below.

In the embodiment illustrated, each protuberance 150 comprises straight edges which are substantially perpendicular to the vertical end edge 152, so as to be able to form a stop element against the movement of a wiper arm in one direction or the other of the longitudinal direction. It should however be noted that only one of the edges, and in particular the edge of the protuberance turned towards the free end edge 144 of the side wall 130, could form a vertical shoulder acting as a stop.

Another stop means forming a fastening plane in the sense of the invention comprises a support wall 162 which extends in a longitudinal L and transverse plane T from the vertical end edge 152 of one of the side walls 130, opposite the receiving space 134 of the platform 16 and the other of the side walls. According to the example of the invention, each of the side walls 130 comprises a support wall 162 as described above.

The support wall 162 comprises at least one contact surface 164, shown in FIG. 7, turned opposite the upper wall 132 and forming a vertical stop means for a type of arm in the first vertical direction SV1. The support wall 162 also comprises at least one receiving surface 165, shown in FIG. 6, opposite the contact surface 164 in the vertical direction V, this receiving surface 165 forming a vertical stop means for a type of arm in a second vertical direction SV2, opposite the first vertical direction SV1.

At least one of the support walls 162 of the adapter 20 also comprises at least one transverse end edge 166 which extends in a longitudinal L and vertical plane V and which forms a transverse stop means for a type of arm on the adapter 20. In the example of the invention, each of the support walls 162 protruding from the side walls 130 has such a transverse end edge 166, and each of the transverse end edges 166 forms a specific fastening plane in a transverse direction.

Of the fastening means provided on the adapter, and as particularly clearly shown in FIG. 6, first fastening means are configured to form two separate fastening paths along the upper wall 132, being a longitudinal fastening path 171 intended to receive a part of a particular type of wiper arm, and a transverse fastening path 169 intended to receive a part of another type of wiper arm. These first fastening means are configured to form at least two separate fastening surfaces in each of the longitudinal, vertical and transverse directions.

More particularly, the first fastening means comprise at least two studs 168 which protrude vertically from the upper wall 132, opposite the receiving space 164. The at least two studs are arranged so as to define two paths which are perpendicular to one another on the upper wall and each able to receive a type of wiper arm.

More precisely, and in accordance with the example of the invention illustrated, the upper wall 132 has a substantially rectangular form with a stud 168 extending at each of the four corners, the first fastening means here being formed by four studs 168. The four studs 168 protruding from the upper wall at a distance from one another define between them a first transverse path 169 and a second longitudinal path 171, which extend respectively in the transverse direction T and in the longitudinal direction L of the adapter.

The first transverse path 169 is defined by first side faces 1681 of each of the studs 168 arranged facing one another on either side of this first transverse path 169. These first side faces 1681 form two different fastening planes in the longitudinal direction, arranged on either side of the first transverse path 169.

Similarly, the second longitudinal path 171 is defined by second side faces 1682 of each of the studs 168 arranged facing one another on either side of this second longitudinal path 171. These second side faces 1682 form two different fastening planes in the longitudinal direction, arranged on either side of the second longitudinal path 171.

Also, each stud has an upper face 1680 opposite the upper wall 132, and these upper faces 1680 form a fastening plane in the vertical direction insofar as, according to the invention and in a usage case of the adapter, this adapter is intended to be fully covered by a type of wiper arm. It should be noted that the fastening plane in the vertical direction defined by the upper faces 1680 is separate from a fastening plane in the vertical direction defined by the upper wall.

As shown on FIG. 6, the adapter 20 comprises at least one through-hole 170 formed in at least one of its side walls 130, such that it is arranged facing the bore of the rotary platform 16, which is intended to form the receiving bearing 90 for the shank of a type of wiper arm. According to the example of the invention, each of the side walls 130 of the adapter 20 comprises a hole 170, formed facing the receiving bearing 90 of the platform 16, the holes 170 being arranged in the transverse extension of the receiving bore when the adapter 20 is removably fixed to the rotary platform 16.

Also, the holes 170 of the adapter 20 are formed on the side walls 130 thereof, such that they are longitudinally arranged between the fixing means 136 of the adapter 20 and the rotary platform 16. In the example illustrated, for a given side wall 130, the first pair of fixing means 136a and the second pair of fixing means 136b are arranged on either side of the holes 170 in the longitudinal direction L.

Each hole is delimited by a peripheral edge formed in the corresponding side wall 130, and this peripheral edge forms stops against the movement of the shank of the wiper arm which is received in the hole or holes. Each hole thus forms a fastening means for the shank and hence for the wiper arm comprising this shank, in both directions of the longitudinal direction and in both directions of the vertical direction, such that the two fastening planes in the longitudinal direction and the two fastening planes in the vertical direction are defined by these holes.

The adapter comprises further fastening means, here called additional fastening means, which take the form of at least one elastically deformable locking tab 108 which extends longitudinally from the one of the side walls 130 of the adapter 20, at the second longitudinal end 158 of the body. “Elastically deformable” means that the locking tab 108 can be deformed and then return to an initial undeformed state without breakage of its material or irreversible deformation. The at least one locking tab 108 comprises a finger 110 formed at a free end of said locking tab 108, opposite the receiving space 134 of the rotary platform 16. The finger may in particular have an inclined face 111 relative to a vertical and transverse plane, forming a ramp able to cooperate with corresponding forms on a type of wiper arm to be fixed, and thus forming a fastening plane in both the vertical direction and the longitudinal direction. According to the example of the invention, a locking tab 108 as described above extends from each of the side walls 130 of the adapter 20, the fingers 110 protruding from the locking tabs opposite one another.

A method for mounting a first type of wiper arm 119a on the adapter 20 will now be described in relation to FIG. 8 to FIG. 10. In this mounting method, some of the above-described fastening means will be used to form a first assembly for connecting the adapter 20 to the first type of wiper arm 119a.

The arm 119a of this first type has an end which may take the form of a shroud 124, fixed to the end of the arm 119a intended to cooperate with the adapter 20 of the connection device 8. The end of the arm 119a in particular comprises two lateral partitions 174, which each extend in a longitudinal L and vertical plane V opposite one another in the transverse direction T, and also comprises at least one upper partition 176, which extends in a longitudinal L and transverse plane T such that it connects the lateral partitions 174 together in order to delimit a receiving volume 178 of the adapter 20 of the connection device 8.

It is understood in particular that the upper partition 176 of the end of the arm 119a is intended to rest on the studs 168 of the adapter 20 forming the first fastening means as stated above, such that the arm is blocked in the second vertical direction SV2. More particularly, the upper face 1680 of the studs 168 forms a fastening plane in the vertical direction which bears the upper partition of the end of the arm 119a, which thus extends offset relative to the upper wall 132 of the adapter which forms another fastening plane used for other types of wiper arm.

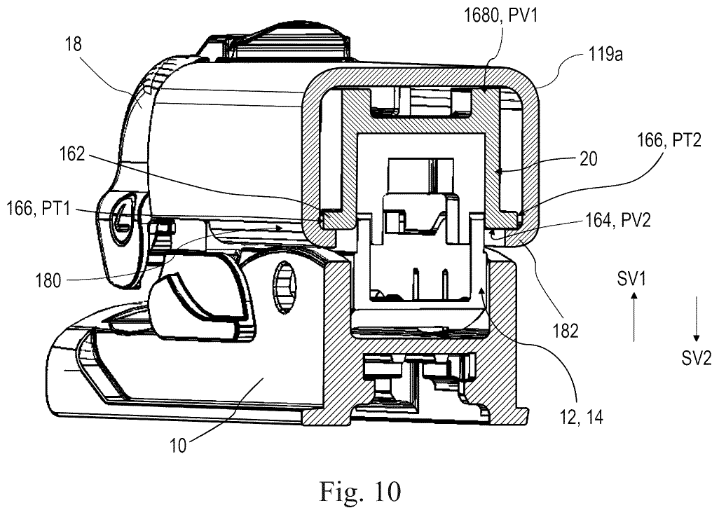

Each of the lateral partitions 174 comprises a free longitudinal edge 180 opposite the upper partition 176. A bent wall 182 extends from each of the free longitudinal edges 180 of each of the lateral partitions 174 in the direction of the receiving volume 178 of the adapter 20. More precisely, each of the bent walls 182 comprises an inner face 184 turned towards the upper partition 176, intended to be in contact with the contact surface 164 of one of the support walls 162 forming one of the stop means of the adapter, the contact surface 164 forming a fastening plane in the vertical direction which is able to block the arm 119a in position on the adapter 20 in the first vertical direction SV1. The adapter 20 thus provides fastening means able to block the vertical position of the first type of wiper arm in both directions, i.e. with two different fastening planes, in the vertical direction PV1, PV2 marked in FIG. 10. Arbitrarily, in this description of the figures, the first fastening plane in the vertical direction PV1 means the fastening plane formed by the upper face 1680 of the studs 168 forming the first fastening means, and the second fastening plane in the direction PV2 means the fastening plane formed by the contact surface 164 of the support walls 162.

As shown in FIG. 8, the end of the arm 119a, here the shroud 124, also comprises at least one finger 186 which extends in the transverse extension of one of the bent walls 182, substantially in the same longitudinal L and transverse plane T in which said bent wall 182 extends. The finger 186 is in particular formed on the end of the arm 119a such that, when this arm is fixed to the removable adapter, it cooperates with the vertical shoulder 154 formed on the adapter 20 at the first longitudinal end 146 thereof. More particularly, the vertical shoulder 154 forms a longitudinal stop on installation of the arm 119a on the removable adapter in a first longitudinal direction SL1, running from the first longitudinal end 146 of the adapter towards the second longitudinal end 158 of the adapter. Arbitrarily, in this description of the figures, the first fastening plane in the longitudinal direction PL1 means the fastening plane formed by the vertical shoulder 154, forming one of the fastening or stop means of the adapter.

Also, FIG. 10 illustrates that the support walls 162 protrude transversely from the adapter in such a dimension that each transverse end edge 166 is substantially in contact with the shroud 124 and helps block the transverse position of the shroud relative to the adapter. The fastening planes formed by each of the transverse end edges 166 are called the first fastening plane in the transverse direction PT1 and the second fastening plane in the transverse direction PT2.

As stated above, the protuberance 150 may comprise two straight edges forming a vertical shoulder such that the arm 119a can be mounted on the removable adapter in a second longitudinal direction SL2, running from the second longitudinal end 158 of the adapter towards the first longitudinal end 146 of the adapter. The description below mainly concerns mounting in the first longitudinal direction SL1, in the context of an application with a connection module comprising a rotary platform, wherein it is recalled that the adapter and the first fastening planes just described could be used without the connection module comprising such a rotary platform.

The mounting method of a wiper system 1 comprising the arm 119a according to the first type comprises at least a first step, during which the cap 18 is moved into its release position. Such a first step may in particular allow release of the free end 44 of the rotary platform 16 such that the latter moves from its working position to its mounting position during a second step. In other words, during the second step, the rotary platform 16 is swivelled into its mounting position such that the main extent axis of the rotary platform is inclined relative to the main extent axis of the base 14.

Such a mounting position of the rotary platform 16 allows, during a third step, the sliding of the shroud 124 of the arm 119a along the rotary platform 16 bearing the adapter 20, in a translation parallel to the main extent axis of the rotary platform 16, this translation being performed in the first longitudinal direction SL1 from the first longitudinal end 146 of the adapter towards the second longitudinal end 158 of the adapter. More precisely, it is possible to define a free end 188 of the shroud 124 of the arm 119a and a connecting end 190 of the shroud 124 of the arm 119a opposite the free end 188 in the longitudinal direction L, wherein the translation of the shroud 124 of the arm 119a along the rotary platform 16 begins by engagement of the connecting end 190 around the first longitudinal end 146 of the adapter in the case of mounting in the first longitudinal direction SL1, or of the free end 188 around the second longitudinal end 148 in the case of mounting in the second longitudinal direction SL2. During this third step, the end of the arm 119a is moved along the adapter 20 such that the inner faces 184 of the bent walls 182 of the arm 119a slide along the contact surface 164 of each of the support walls 162 of the adapter 20, until the finger 186 of the shroud 124 comes into contact with the vertical shoulder 154 formed on the adapter 20 and forming a longitudinal stop means in the first longitudinal direction SL1 or in the second longitudinal direction SL2.

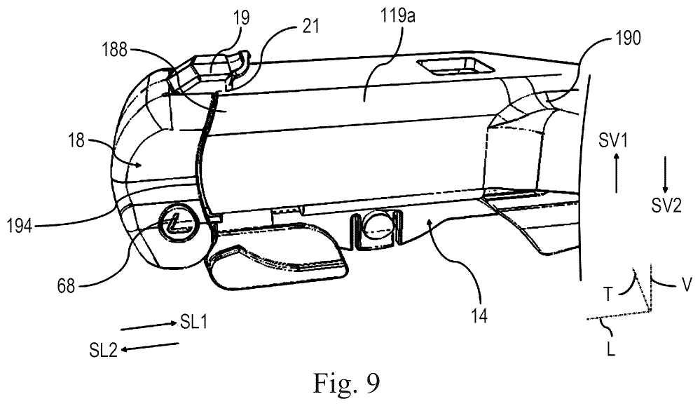

Then, during a fourth step, the rotary platform 16 bearing the adapter 20 and the end of the arm 119a secured to this adapter is moved into its working position, such that its free end 44 cooperates with the guide block 42 of the base 14 of the connection module 12. Finally, in a fifth step, the cap 18 is swivelled from its release position to its covering position such that it forms a vertical stop means for the arm in the first vertical direction SV1 and a longitudinal stop means for the arm in the second longitudinal direction SL2. More particularly, an edge of the cap 18 comes into contact with the upper partition 176 of the shroud 124 when the cap is moved into its covering position, as shown on FIG. 9. Also, during this fifth step, the extension wall 19 and in particular the inner surface 21 of the extension wall 19 is arranged facing the upper partition 176 of the shroud 124 at its free end 188, and forms a vertical stop means for the arm in the first vertical direction SV1.

As an alternative to the process just described, the arm 119 may be mounted with a connection module without rotary platform. In this case, the method still comprises the first step of releasing the cap, and the shroud is then arranged above the connection module in order to be positioned, with a vertical movement direction SV2, in contact with the studs 168 of the removable adapter. The shroud is locked in its vertical position when it is in contact with the second fastening plane in the above-mentioned vertical direction SV2, formed by the upper faces of the studs 168. It should be ensured here that the finger 186 of the shroud 124 slides vertically correctly, facing the first longitudinal end 146 of the adapter. In accordance with the above description of the third step, the arm is then moved in the first longitudinal direction SL1 from the first longitudinal end 146 of the adapter towards the second longitudinal end 158 of the adapter, until the finger 186 of the shroud 124 comes into contact with the vertical shoulder 154 formed on the adapter 20 and forming a first fastening plane in the longitudinal direction PL1. In this position, after the longitudinal sliding has been blocked by the first fastening plane in the longitudinal direction PL1, the bent wall 182 is arranged facing the stop means formed by the support wall 162 of the adapter, and the first fastening plane in the vertical direction PV1 ensures the blocking of the arm relative to the adapter in the vertical direction.

As a result of this, the first connection assembly is thus formed by at least multiple fastening means borne by the adapter, including the studs 168 which here in particular participate in the blocking of the arm against a vertical component, the support wall 162 which participates in particular in the blocking of the arm against a vertical component and a transverse component, and the straight edge or edges of the protuberance 150, forming a vertical shoulder 154 which acts in the direction of longitudinal displacement SL1 or SL2, and participates or participate in the blocking of the arm against a longitudinal component.

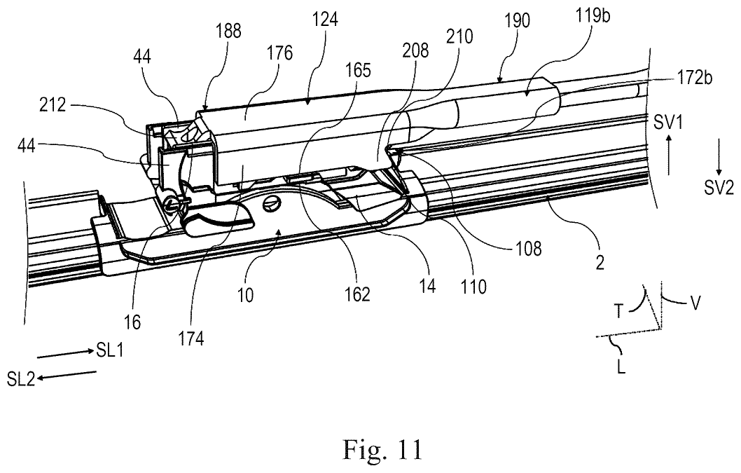

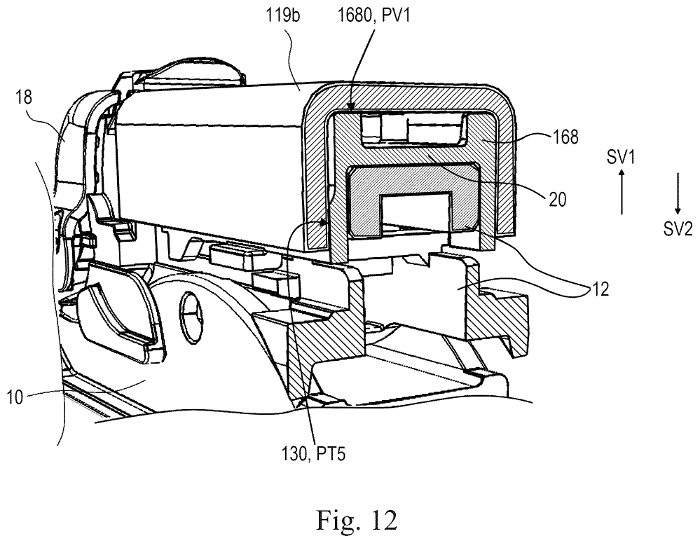

A method for mounting a second type of wiper arm 119b on the adapter 20 will now be described in relation to FIG. 11 and FIG. 12. In this mounting method, some of the fastening means will be used to form a second assembly for connecting the adapter 20 to the second type of wiper arm 119b. It should be recalled that only the features which differ between the first arm 119a and the second arm 119b will form the subject of the detailed description, and for the features common to both types of arm, reference should be made to the description of FIG. 8 and FIG. 9.

The second type of arm 119b according to the invention, like the first type of arm, comprises an upper partition 176 and two lateral partitions 174 formed by the free end of the arm, where appropriate via a shroud 124. At least one rear tab 208 extends from at least one of the lateral partitions 174 of the end of the arm 119b, in the present case at the connecting end 190 of the shroud 124. The rear tab 208 is configured to cooperate with a finger 110 of one of the locking tabs 108 of the adapter 20. According to the example of the invention, a rear tab 208 as described above extends from each of the lateral partitions of the shroud, and each of these rear tabs is configured to cooperate with a finger 110 of a locking tab.

The second type of arm 119b according to the invention also comprises at least one nose 212 which extends from the upper partition 176 at the free end 188 of the arm. More particularly, the nose 212 extends in a substantially longitudinal direction L and has an inwardly curved profile extending substantially inside the receiving volume 178 of the adapter. The nose 212 is here intended to be housed in the free end 44 of the rotary platform 16, which is itself housed in the guide block 42 of the base 14 when the rotary platform is in the above-mentioned working position.

Mounting of such a second type of arm 119b according to the invention may take place with the rotary platform 16 in its mounting position or, in a configuration without rotary platform, when the cap 18 is moved from its covering position to its release position in a first step. In a second step, the end of the arm 119b is placed on the adapter 20 by inclining the end of the arm relative to the plane containing the upper wall 132 of the adapter, and by moving the end of the arm in the first longitudinal direction SL1 such that a rear surface 210 of the at least one rear tab 208 comes into contact with the corresponding finger 110 of a locking tab 108 of the adapter 20. The second type of arm 119b is thus blocked in position on the adapter 20 in the first longitudinal direction SL1, a face of the locking tab forming a fastening plane in the longitudinal direction which, following the arbitrary designation of the description of the figures, is here called the second fastening plane in the longitudinal direction PL2.

More particularly, this face of the tab comprises an inclined face 111 relative to a vertical and transverse plane, which then forms the second fastening plane in the longitudinal direction PL2 and also a third fastening plane in the vertical direction PV3.

After the second step, during a third step, the end of the arm 119b is swivelled such that its free end 188 bearing the nose 212 comes to be positioned in the free and 44 of the rotary platform 16, and its upper partition 176 rests on the studs 168 of the adapter 20. It is understood in particular that the upper faces of the studs 168 of the adapter 20 block the arm 119b in position on the adapter 20 in the second vertical direction SV2, along the above-described second fastening plane in the vertical direction PV2, as visible in particular in FIG. 12.

Finally, in a fifth step, the cap 18 is moved into its covering position such that it blocks the end of the arm 119b of the adapter 20 in the vertical V and longitudinal directions L, and more particularly in the second longitudinal direction SL2 and the first vertical direction SV1.

As a result of this, the second connection assembly is thus formed by multiple fastening means borne by the adapter, wherein the upper faces of the studs 168 and the locking tabs 108 work in synergy to block the second type of wiper arm 119b. The majority of the fastening means for allowing fixing of this type of arm are borne by the adapter, and only the cap is also used to fix the position of the arm.

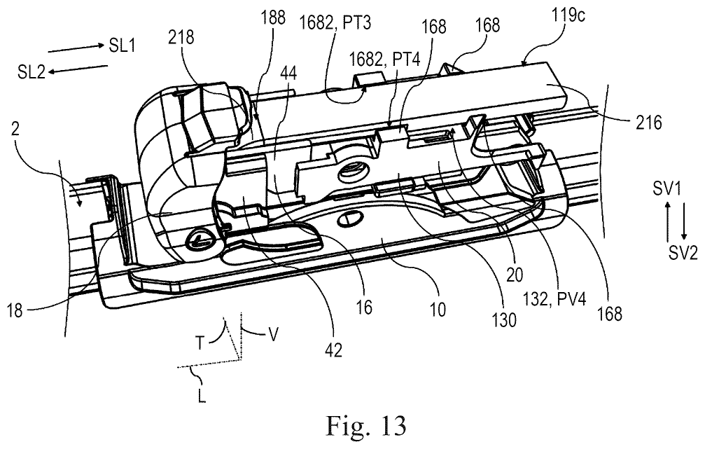

A method for mounting a third type of wiper arm 119c on the adapter 20 will now be described in relation to FIG. 13. In this mounting method, some of the fastening means will be used to form a third assembly for connecting the adapter 20 to the third type of wiper arm 119c.

The third type of wiper arm 119c according to the invention takes the form of a hook, which extends in the longitudinal direction L and is arranged in the second longitudinal path 171 formed between the studs 168 of the adapter 20. More precisely, the wiper arm 119c according to this third type comprises at least a rectilinear portion 216 and a bent portion 218 at its free end 188, the rectilinear portion 216 extending between the studs 168 of the adapter 20 in the second longitudinal path 171, and the bent portion 218 extending beyond the first longitudinal end 146 of the adapter 20, in particular surrounding the free end 44 of the rotary platform 16.

Thus a method of mounting such an arm 119c according to the third type comprises at least a first step, during which the cap 18 is moved into its release position. In a second step, the arm 119c is placed on the adapter 20 such that its rectilinear part 216 is housed in the second longitudinal path 171 and its bent part 218 is positioned around the connection module, here the free end 44 of the rotary platform 16. The first fastening means formed by the studs 186, in particular at their second side surface 1862 delimiting the second longitudinal path 171, here form two fastening planes in the transverse direction, arranged on either side of the second longitudinal path 171 and here called the third fastening plane in the transverse direction PT3 and the fourth fastening plane in the transverse direction PT4. It should also be noted that here the upper wall 132 forms a fastening plane in the vertical direction, since the arm 119c rests on this upper wall in the second longitudinal path 171, the upper wall here forming a fourth fastening plane in the vertical direction PV4. Finally, in a fourth step, the cap 18 is moved into its covering position such that it blocks the free end 44 of the rotary platform 16 in the guide block 42 of the base 14, thus blocking the arm 119c in position on the adapter 20.

As a result of this, the third connection assembly is thus formed by multiple fastening means borne by the adapter, including the studs 168 which here participate in particular in the blocking of the arm against a transverse component by defining a longitudinal path, and the upper wall of the adapter from which these studs protrude and which participates in particular in the blocking of the arm against a vertical component.

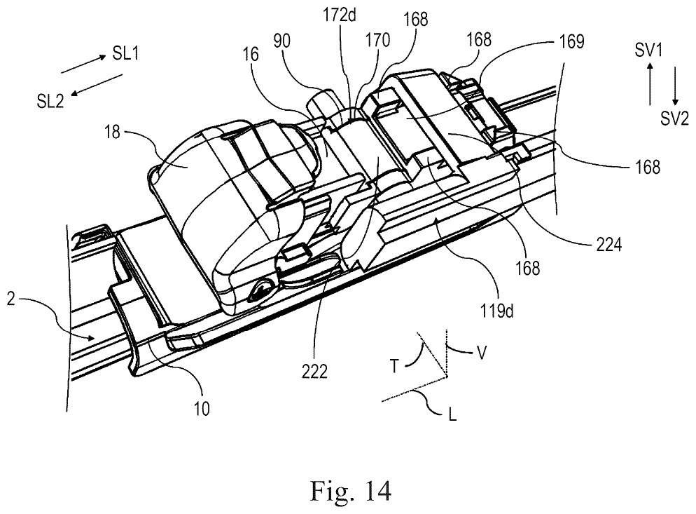

A method for mounting a fourth type of wiper arm 119d on the adapter 20 will now be described in relation to FIG. 14. In this mounting method, some of the above-described fastening means will be used to form a fourth assembly for connecting the adapter 20 to the fourth type of wiper arm 119d, which is mounted laterally on the connection device and associated adapter 20.

The fourth type of wiper arm 119d comprises at least one shank 222 and a support lug 224, which both extend from the arm 119d in the transverse direction T. More precisely, the shank 222 protrudes transversely from the end of the wiper arm, such that this shank 222 is housed in the receiving bearing 90 of the rotary platform 16 and in the holes 170 of the adapter 20 arranged facing the receiving bearing. Also, the support lug 224 extends transversely from the arm 119d such that it is housed in the first transverse path 169 formed between the studs 168 of the adapter 20.

Thus the method of mounting such a fourth type of arm 119d comprises at least a first step, during which the shank 222 is inserted in the holes 170 of the adapter 20 formed facing the receiving bearing 90 of the rotary platform 16, by arranging the arm 119d with a main orientation which is inclined relative to the main extent direction of the adapter and of the connection device as a whole, such that the support lug 224 does not come into contact with the studs 168 of the adapter 20. Here, the walls delimiting the holes 170 ensure that the shank 222 is blocked in its longitudinal and vertical position in both directions, and thus form two fastening planes in opposition in the vertical direction, arbitrarily called the fourth fastening plane in the vertical direction PV4 and the fifth fastening plane in the vertical direction PV5, and two fastening planes in opposition in the longitudinal direction, arbitrarily called the third fastening plane in the longitudinal direction PL3 and the fourth fastening plane in the longitudinal direction PL4, these different fastening planes being marked on FIG. 6. Then, in a second step, the arm 119d is swivelled on the adapter 20 about an axis formed by the shank 222 in the receiving bearing, such that the support lug 224 comes to be positioned in the first transverse path 169 of the adapter 20. At its free end, the support lug 224 has a return edge which, in this movement, comes to be positioned facing a side wall of the adapter opposite the arm. This side wall forms a fastening plane in the transverse direction, here arbitrarily called the fifth fastening plane in the transverse direction PT5. It should be noted that the fifth fastening plane in the transverse direction PT5, formed by this side wall 130, is also used in the mounting of the third type of wiper arm 119c which, as shown in FIG. 12, is transversely pressed against this side wall 130.

With respect to the cooperation of the adapter with the fourth type of arm 119d, the first fastening means formed by the studs 186, in particular at their first side surface 1861 delimiting the first transverse path 169, here form two fastening planes in the longitudinal direction arranged on either side of the first transverse path 169 and here called the fifth fastening plane in the longitudinal direction PL5 and the sixth fastening plane in the longitudinal direction PL6. It should also be noted that, in accordance with the above description for the third type of arm, here the upper wall 132 forms a fastening plane in the vertical direction since the fourth type of arm 119d rests on this upper wall, here in the first transverse path 169, the upper wall here again forming the fourth fastening plane in the vertical direction PV4.

As a result of this, the fourth connection assembly is thus formed by multiple fastening means borne by the adapter, including the studs 168 which here in particular participate in the blocking of the arm against a longitudinal component by defining a transverse path, the upper wall of the adapter from which these studs protrude and which participates in particular in the blocking of the arm against a vertical component, and the holes 170 which here in particular participate in the blocking of the arm via the shank against a longitudinal component and a vertical component, the arm being blocked against a transverse component by the cooperation of the support lug with a side wall of the adapter, which here forms one of the fastening means.

The detailed description above, and in particular that of the connection assemblies and the various mounting examples, illustrates that the present invention achieves its set objectives, in particular allowing fixing of different types of wiper arm via a single adapter which provides a plurality of fastening planes, and in particular at least four different fastening planes in each of the longitudinal, vertical and transverse directions which are perpendicular to one another.

The invention as described above is not, however, limited to the means and configurations exclusively described and illustrated, and also applies to all equivalent means or configurations and to any combination of such means or configurations.

What is claimed is:

1. An adapter for a device for connecting a wiper blade to an arm of a wiper system, the connection device including at least a connection module and the adapter which extends in a longitudinal main extent direction, the adapter comprising at least two side walls opposite one another in a transverse direction of the adapter, at least one upper wall which extends in a longitudinal and transverse plane so as to connect the side walls together, reversible fixing means configured to removably fix the adapter to the connection module, wherein the adapter includes fastening means for at least a plurality of different types of wiper arms, the fastening means being configured to provide at least four different fastening planes in each of the longitudinal and transverse directions and in a vertical direction perpendicular to these two longitudinal and transverse directions.

2. The adapter as claimed in claim 1, wherein a first fastening means are configured to form two fastening paths for a type of wiper arm along the upper wall, being a longitudinal fastening path and a transverse fastening path.

3. The adapter as claimed in claim 2, wherein the fastening means comprise additional fastening means which are offset at least longitudinally relative to the first fastening means, the first fastening means and the additional fastening means being configured to allow, in synergistic fashion, the fixing of another type of wiper arm and/or the fixing of a covering element of the connection module.

4. The adapter as claimed in claim 1, wherein the side walls and the upper wall delimit a receiving space of the connection module, the reversible fixing means being formed in this receiving space.

5. The adapter as claimed in claim 2, wherein the first fastening means includes at least two studs protruding from the upper wall of the adapter, the studs being arranged such that the side faces of the studs at least partially delimit the fastening paths by defining two different fastening planes in each of the longitudinal and transverse directions.

6. The adapter as claimed in claim 5, wherein the studs have an upper face perpendicular to the side faces, the upper faces defining a separate vertical fastening plane parallel to a vertical fastening plane defined by the upper wall.

7. The adapter as claimed in claim 3, wherein the additional fastening means includes at least one elastically deformable locking tab which longitudinally extends the one of the side walls of the adapter.

8. The adapter as claimed in claim 7, wherein the at least one locking tab includes at least one overthickness which protrudes transversely from a free end of the locking tab, the overthickness forming an additional longitudinal fastening plane, an additional transverse fastening plane, and an additional vertical fastening plane for the other type of wiper arm and/or the cover element of the connection module.

9. The adapter as claimed in claim 1, wherein one of the fastening means includes a stop means locally extending the one of the side walls opposite the upper wall, the stop means being configured to form a longitudinal fastening plane or a vertical fastening plane.

10. The adapter as claimed in claim 1, wherein one of the fastening means includes at least one through-hole formed on the at least one of the side walls of the adapter.

11. A connection assembly comprising an adapter and a connection module, the adapter being able to be removably fixed to the connection module via reversible fixing means, the adapter including at least two side walls opposite one another in a transverse direction of the adapter, at least one upper wall which extends in a longitudinal and transverse plane so as to connect the side walls together, reversible fixing means configures to removably fix the adapter to the connection module, wherein the adapter includes fastening means for at least a plurality of different types of wiper arms, the fastening means being configured to provide at least four different fastening planes in each of the longitudinal and transverse directions and in a vertical direction perpendicular to these two longitudinal and transverse directions.

12. A device for connecting a wiper blade to an arm of a wiper system, the connection device comprising at least one connector and a connection assembly the connection assembly being attached to the connector by a cooperation of the connector with the connection module, the connection assembly including an adapter and a connection module, the adapter being able to be removably fixed to the connection module via reversible fixing means, the adapter including at least two side walls opposite one another in a transverse direction of the adapter, at least one upper wall which extends in a longitudinal and transverse plane so as to connect the side walls together, reversible fixing means configured to removably fix the adapter to the connection module, wherein the adapter includes fastening means for at least a plurality of different types of wiper arms, the fastening means being configured to provide at least four different fastening planes in each of the longitudinal and transverse directions and in a vertical direction perpendicular to these two longitudinal and transverse directions.

13. (canceled)
